(19) United States
(12) Patent Application Publication
(10) Pub. No.: US 2010/0198449 A1
(43) Pub. Date: Aug. 5, 2010

(54) VEHICULAR CONTROL DEVICE AND METHOD OF CONTROLLING A VEHICLE

(75) Inventors: Kiyoshiro Ueoka, Nissin-shi (JP); Yuichi Tanaka, Toyota-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/678,183

(22) PCT Filed: Jul. 29, 2008
(86) PCT No.: PCT/JP2008/063940

§ 371 Date: Mar. 15, 2010

(30) Foreign Application Priority Data
Sep. 13, 2007 (JP) 2007-237950

(51) Int. Cl. B60T 7/12; G06F 7/00

(52) U.S. Cl. 701/29

(57) ABSTRACT

In a vehicle having a brake hold control function an ECU cancels brake hold control when an actual value of a degree of operation of the accelerator pedal is larger than a predetermined degree. The ECU calculates a rate of increasing the vehicle's requested driving force after the brake hold control is cancelled such that the rate is larger for longer times having elapsed since the brake hold control was cancelled and the rate is also larger for larger actual values of the degree of operation of the accelerator pedal, as shown in FIG. 6.

### TECHNICAL FIELD

The present invention relates generally to controlling vehicles and particularly to controlling vehicles having a brake hold control function holding a braking force while the driver does not press a brake pedal.

### BACKGROUND ART

In recent years a vehicle including an automatic transmission is known that reduces a burden on a driver operating a brake in a traffic jam and the like. More specifically, when the vehicle is stopped in a forward position and in that condition once the vehicle has the brake pedal operated to a degree (e.g., in an amount) larger than a predetermined degree, then thereafter even if the brake pedal is not operated the braking force applied when the vehicle is stopped is held (i.e., brake hold control is exerted). In starting a vehicle subjected to the brake hold control, when the driver releases his/her foot from the brake pedal, a force applied to brake the vehicle when the vehicle is stopped is held. Furthermore, the vehicle subjected to the brake hold control is adapted such that when the driver operates the accelerator pedal the brake hold control can be cancelled to start the vehicle. Thus in starting the vehicle on an uphill road when the driver releases his/her foot from the brake pedal the vehicle does not reverse and is thus readily started. In starting the vehicle on a downhill road, when the accelerator pedal is pressed the brake hold control is cancelled, and the acceleration attributed to the engine and that attributed to the downhill road are simultaneously exerted and the vehicle may suddenly start. To resolve this problem, for example Japanese Patent Laying-Open No. 10-329671 discloses a technique.

Japanese Patent Laying-Open No. 10-329671 discloses a brake control system including a brake hold function. More specifically, when a vehicle is stopped and the driver releases his/her foot from the brake pedal, the function holds a braking pressure applied from a master cylinder linked with the brake pedal. The brake control system includes a gradient determination unit determining a gradient of a road at least from a degree of operation of an accelerator pedal of the vehicle, and a control unit exerting control to release the held braking pressure if the road's gradient is a downhill gradient.

According to Japanese Patent Laying-Open No. 10-329671, the brake control system allows a road's gradient to be determined at least from a degree of operation of an accelerator pedal and if the gradient is a downhill gradient a held braking pressure is released. Thus in starting the vehicle on a downhill road the held braking pressure has been released. The acceleration attributed to the engine and that attributed to the downhill road are not simultaneously exerted and the vehicle can avoid suddenly starting.

For example, to detect a driver's request for acceleration more precisely, a degree of operation of an accelerator pedal that has attained a predetermined value, rather than the accelerator pedal being simply operated, may be considered as the driver's request for acceleration and the brake hold control may accordingly be cancelled. In that case, a driving force will be output slightly later than the accelerator pedal is operated. Furthermore, in starting a vehicle, it is necessary that a degree of increasing a driving force be limited to prevent a shock otherwise caused as the vehicle suddenly starts. However, when brake hold control is cancelled, an excessively limited degree of increasing a driving force results in a driving force as the driver requests output further later and the driver's requested startability of the vehicle may not be obtained.

### DISCLOSURE OF THE INVENTION

The present invention has been made to overcome the above disadvantage, and it contemplates a control device and a controlling method in a vehicle including a brake hold control function, that can suppress a shock caused when brake hold control is cancelled as the vehicle suddenly starts, while also achieving startability as the driver requests.

The present vehicular control device controls a vehicle having a brake hold control function causing a braking device to operate to hold a braking force while the driver of the vehicle does not press a brake pedal, and stopping the braking device from operating when a degree of acceleration requested by the driver is larger than a predetermined degree. The vehicular control device includes a detection unit for detecting the degree requested, and a control unit connected to the detection unit. While the brake hold control is exerted, the control unit determines whether the degree requested, as detected by the detection unit, exceeds the predetermined degree, and the control unit detects a period of time having elapsed since the degree requested exceeded the predetermined degree, and for the degree requested having exceeded the predetermined degree, before the period of time having elapsed exceeds a predetermined time, the control unit sets a degree of increasing requested driving force, as based on the period of time having elapsed and the degree requested, calculates the requested driving force, as based on the degree as set of increasing the requested driving force, and controls force driving the vehicle, as based on the requested driving force as calculated.

According to the present invention while brake hold control is exerted when a degree of acceleration requested by a driver (e.g., an actual value of a degree of operation of an accelerator pedal) exceeds a predetermined degree the brake hold control function is stopped. After the degree of acceleration requested exceeds the predetermined degree before a period of time exceeding a predetermined time elapses a degree of increasing requested driving force is set as based on the period of time having elapsed and the degree requested. Thus, for example immediately after the brake hold control is cancelled or when a small degree of acceleration is requested, a small degree of increasing requested driving force can be set to prevent a shock otherwise caused when the vehicle suddenly starts. On the other hand, for example when some period of time has elapsed since the brake hold control was cancelled or when a large degree of acceleration is requested, a large degree of increasing requested driving force can be set to early output driving force as the driver requests. A control device can thus be provided that allows a vehicle operative in response to a degree of acceleration requested by the driver to cancel brake hold control to reduce shock otherwise caused while the brake hold control is cancelled as the vehicle suddenly starts and to achieve startability as the driver requests.

Preferably, the control unit sets an amount by which the requested driving force is increased per unit time to be larger amounts for larger values of the degree requested.

According to the present invention, an amount by which the requested driving force is increased per unit time is set to be larger amounts for larger values of the degree requested. A driving force corresponding to a degree of acceleration requested by the driver can thus be output earlier.

Still preferably, the control unit sets an amount by which the requested driving force is increased per unit time to be larger amounts for larger values of the period of time having elapsed.

According to the present invention, an amount by which the requested driving force is increased per unit time is set to be larger amounts for larger values of the period of time having elapsed. Thus, immediately after the brake hold control is cancelled, when the vehicle suddenly starts and thus causes a large shock, the amount by which the requested driving force is increased per unit time can be set to be small to gently increase the driving force. Furthermore, depending on a period of time having elapsed thereafter, the amount by which the requested driving force is increased per unit time can be set to be large to output a driving force as the driver requests early.

Still preferably, the braking device is a hydraulic braking device and the predetermined time is set as based on a period of time elapsing after the braking device starts to reduce the pressure of a brake fluid before the braking device completes reducing the pressure of the brake fluid.

According to the present invention, the braking device is a hydraulic braking device and the predetermined time is set as based on a period of time elapsing after the braking device starts to reduce the pressure of a brake fluid before the braking device completes reducing the pressure of the brake fluid. While reducing the brake fluid's pressure is not completed (i.e., while a braking force is exerted), rapidly increased requested driving force can be avoided. Wasteful energy consumption can thus be prevented.

### BRIEF DESCRIPTION OF THE DRAWINGS

FIG. 1 shows a configuration of a vehicle having mounted therein a control device of the present invention in an embodiment.

FIG. 2 represents a characteristic of an output of an accelerator pedal position sensor.

FIG. 3 is a block diagram in function of the control device of the present invention in the embodiment.

FIGS. 4 and 5 are flowcharts for illustrating a structure of an ECU serving as the control device of the present invention in the embodiment for control.

FIG. 6 represents a relationship between time elapsing after brake holding is cancelled and an actual value A of a degree of operation of an accelerator pedal, and a rate of increasing a requested driving force F.

FIG. 7 is timing plots of requested driving force F in a vehicle having mounted therein a control device according to an embodiment of the present invention.

### BEST MODES FOR CARRYING OUT THE INVENTION

Hereinafter reference will be made to the drawings to describe the present invention in embodiments. In the following description, identical components are denoted by identical reference characters. Their names and functions are also identical. Accordingly, they will not be described repeatedly in detail.

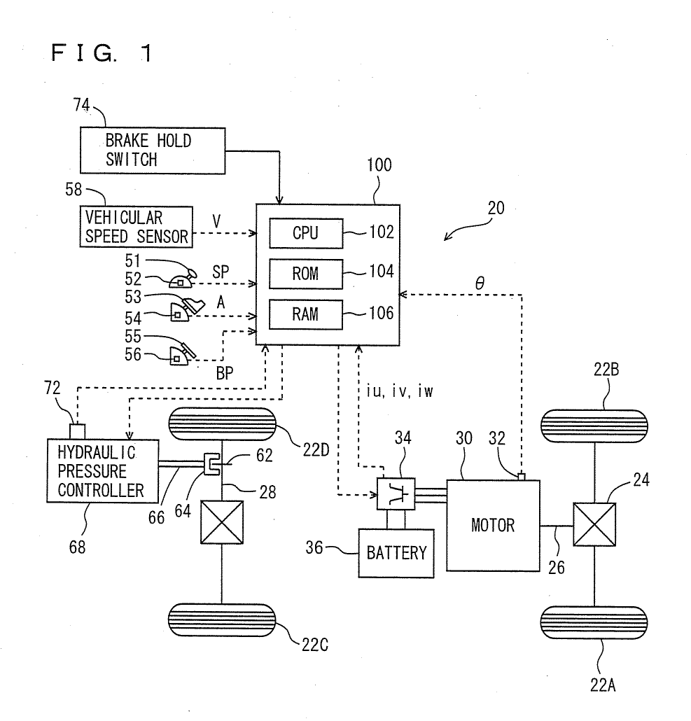

With reference to FIG. 1, the present embodiment provides a control device mounted in an electric vehicle 20 configured as will be described hereinafter. The present control device is not only applicable to the FIG. 1 electric vehicle: it is applicable to an electric vehicle having a different manner. Furthermore, the vehicle may not be an electric vehicle: it may be a hybrid vehicle traveling by the motive power of an engine and a motor.

Electric vehicle 20 includes wheels 22A, 22B, 22C, 22D, a propeller shaft 26 connected to wheels 22A, 22B via a differential gear 24, a motor 30 outputting motive power to propeller shaft 26 for driving the wheels for traveling, a battery 36 supplying motor 30 with electric power via an inverter 34, and an electronic control unit (ECU) 100 generally controlling electric vehicle 20.

Motor 30 is configured for example as a well known, permanent magnetic (PM) type, synchronous motor generator and driven by 3-phase alternate current electric power received from inverter 34.

Inverter 34 is configured as a well known inverter circuit having 6 switching elements, and receives direct current electric power from battery 36 and supplies it for example by pulse width modulation (PWM) control as pseudo 3-phase alternate current electric power to motor 30.

ECU 100 is configured as a microprocessor with a central processing unit (CPU) 102 serving as a center, and has other than CPU 102 a read only memory (ROM) 104 storing a processing program, a random access memory (RAM) 106 temporarily storing data, and an input/output port (not shown).

Electric vehicle 20 further includes a brake disk 62 provided at a drive shaft 28 connected to wheel 22D, a brake mechanism 64, a brake pipe 66, and a hydraulic pressure controller 68. Note that brake disk 62, brake mechanism 64 and brake pipe 66 may be provided for each wheel 22A, 22B, 22C, 22D.

Brake mechanism 64 receives the pressure of a brake fluid introduced into brake pipe 66 and in accordance with the brake fluid's pressure received sandwiches brake disk 62 to generate frictional braking force (hydraulic brake). Hydraulic pressure controller 68 receives a brake control signal from ECU 100 and adjusts the brake fluid's pressure in brake pipe 66 to have a value corresponding to the brake control signal.

ECU 100 receives: a detection signal θ from a rotational position detection sensor 32 detecting a rotational position of a rotor of motor 30; phase currents iu, iv, iw from a current sensor (not shown) attached to each phase of inverter 34; a shift position SP from a shift position sensor 52 detecting a position at which a shift lever 51 is operated; an actual value A of a degree of operation of an accelerator pedal from an accelerator pedal position sensor 54 detecting an amount by which accelerator pedal 53 is operated; an amount by which brake pedal 55 is operated BP from a brake pedal position sensor 56 detecting the amount by which the brake pedal is operated; vehicular speed V from a vehicular speed sensor 58; and the like through an input port.

Accelerator pedal position sensor 54 detects actual value A of a degree of operation of the accelerator pedal as a degree of acceleration requested by the driver, and transmits to ECU 100 a signal representing a result of the detection. Actual value A of a degree of operation of the accelerator pedal, as referred to herein, means a ratio of a current amount of operation of accelerator pedal 53 relative to a maximum amount of operation of accelerator pedal 53. The present invention is not limited to that accelerator pedal position sensor 54 detects actual value A of a degree of operation of the accelerator pedal. For example, accelerator pedal position sensor 54 may detect a current amount of operation of accelerator pedal 53, and ECU 100 may detect actual value A of a degree of operation of the accelerator pedal.

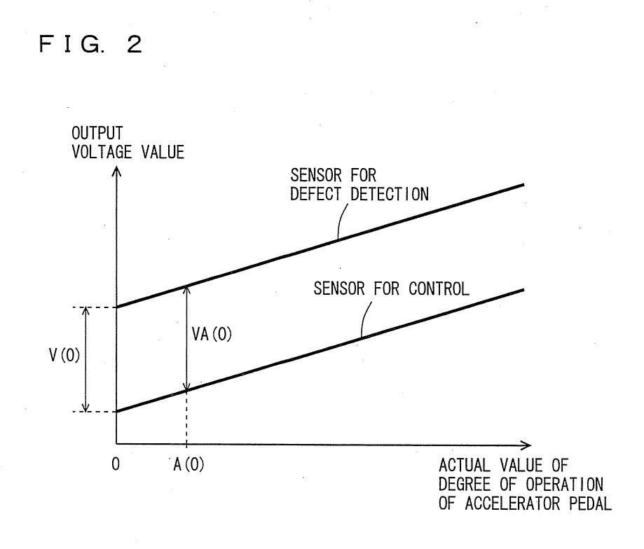

Accelerator pedal position sensor 54 includes two position sensors (not shown), i.e., a sensor for control and a sensor for defect detection, to ensure reliability for detection. The sensor for control and the sensor for defect detection have different output characteristics, as shown in FIG. 2. The sensor for control and the sensor for defect detection have their respective output voltage values with a difference of V(0) for an actual value A of a degree of operation of the accelerator pedal of zero. When the sensor for control and the sensor for defect detection normally function, and actual value A of a degree of operation of the accelerator pedal increases, the sensor for control and the sensor for defect detection have their respective output voltage values having a characteristic increasing the values at the same rate. Their respective output voltage values thus have a difference held at V(0). This characteristic is utilized to allow accelerator pedal position sensor 54 to monitor a voltage difference VA(0) for actual value A of a degree of operation of the accelerator pedal of a degree A(0), and if voltage difference VA(0) is maintained at V(0), a decision is made that accelerator pedal position sensor 54 normally functions. In other words, to ensure the driver's request for acceleration in reliability, it is necessary that actual value A of a degree of operation of the accelerator pedal be larger than degree A(0) as predetermined.

Furthermore, ECU 100 receives signals from a brake fluid pressure sensor 72 and a brake hold switch 74 via an input port.

Brake fluid pressure sensor 72 detects the brake fluid's pressure in brake pipe 66 that is adjusted by hydraulic pressure controller 68, and brake fluid pressure sensor 72 transmits to ECU 100 a signal representing a result of detecting the pressure.

Brake hold switch 74 is operated by a driver to select whether the driver desires to exert brake hold control, as will be described later. If brake hold switch 74 is turned on, brake hold switch 74 transmits to ECU 100 a signal representing that the driver desires to exert the brake hold control. If brake hold switch 74 is turned off, brake hold switch 74 transmits to ECU 100 a signal representing that the driver does not desire to exert the brake hold control.

ECU 100 sets a controlled value AC of a degree of operation of the accelerator pedal based on actual value A of the degree of operation of the accelerator pedal and the vehicle's condition. Controlled value AC of a degree of operation of the accelerator pedal is used as a controlled value of a degree of acceleration requested by a driver, to control a force output to drive the vehicle. When ECU 100 causes electric vehicle 20 to travel, ECU 100 calculates requested driving force F based on controlled value AC of a degree of operation of the accelerator pedal and vehicular speed V and controls motor 30 to drive motor 30 to cause motor 30 to output a torque corresponding to requested driving force F as calculated. In other words, in controlling a force output to drive electric vehicle 20, actual value A of a degree of operation of the accelerator pedal is not used directly. Rather, controlled value AC of the degree of operation of the accelerator pedal that is set by ECU 100 in accordance with actual value A of the degree of operation of the accelerator pedal, is used.

To allow motor 30 to receive a motor current generating the torque corresponding to requested driving force F, ECU 100 generates a switching control signal controlling a switching element that configures inverter 34 to turn on/off. Inverter 34 performs electric power conversion in response to the switching control signal to supply motor 30 with alternate current electric power.

Furthermore, when brake hold switch 74 is turned on, ECU 100 exerts the brake hold control to alleviate a burden imposed on the driver's braking operation in a traffic jam or the like. More specifically, ECU 100 detects shift position SP, vehicular speed V, actual value A of a degree of operation of the accelerator pedal, and the amount by which the brake pedal is operated BP. If shift position SP is a forward position (a D position), actual value A of the degree of operation of the accelerator pedal is approximately zero, vehicular speed V is approximately zero (i.e., the vehicle is currently stopped) and once the amount by which the brake pedal is operated BP has exceeded a predetermined threshold value, then ECU 100 exerts control such that the braking force applied when the vehicle is stopped is held even if the amount by which the brake pedal is operated BP is reduced after amount BP has exceeded the predetermined threshold value.

When accelerator pedal 53 is operated and actual value A of the degree of operation of the accelerator pedal exceeds predetermined degree A(0) as aforementioned (i.e., the driver's request for acceleration is ensured in reliability), ECU 100 cancels exerting the brake hold control.

Furthermore, ECU 100 while the brake hold control is exerted continues the brake hold control and thus holds a braking force until actual value A of the degree of operation of the accelerator pedal is increased to be larger than predetermined degree A(0). To do so, ECU 100 while the brake hold control is exerted sets controlled value AC of the degree of operation of the accelerator pedal at zero to save energy otherwise wastefully consumed, and once actual value A of the degree of operation of the accelerator pedal has attained predetermined degree A(0), ECU 100 gradually converges controlled value AC of the degree of operation of the accelerator pedal to actual value A of the degree of operation of the accelerator pedal to prevent the vehicle from suddenly starting.

Furthermore, ECU 100 calculates requested driving force F from controlled value AC of the degree of operation of the accelerator pedal and vehicular speed V and controls inverter 34 to cause motor 30 to output a torque corresponding to requested driving force F.

Furthermore, to prevent a shock caused when the vehicle starts or the like, ECU 100 performs a process to gently increase requested driving force F when it is around zero (i.e., around a point at which a direction in which a torque added to a driving system such as differential gear 24 or the like acts changes (hereinafter this process will also be referred to as “the gentle variation process”).

In the present embodiment, while brake holding is cancelled, controlled value AC of a degree of operation of an accelerator pedal is increased once actual value A of the degree of operation of the accelerator pedal has attained a predetermined angle. Consequently, a driving force will be output slightly later than accelerator pedal 53 is operated. Furthermore, while brake holding is cancelled, a process is performed to gently vary requested driving force F. When the process is performed with an excessively limited degree of increasing a driving force, a driving force corresponding to the driver's request would be output further later and the driver's requested startability of the vehicle may not be obtained.

Accordingly the present embodiment provides a control device that while brake hold control is cancelled increases a rate R of increasing requested driving force F in the gentle variation process, as based on time T having elapsed since the brake hold control was cancelled and actual value A of a degree of operation of the accelerator pedal.

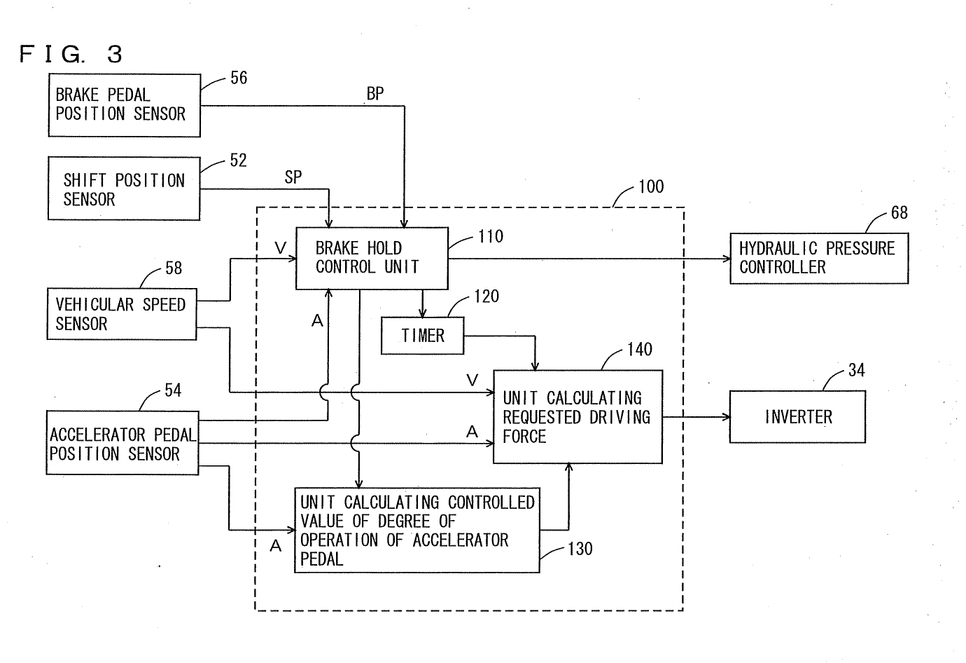

FIG. 3 is a block diagram in function of the control device in the present embodiment. As shown in FIG. 3, the control device includes a brake hold control unit 110, a timer 120, a unit 130 calculating a controlled value of a degree of operation of an accelerator pedal, a unit 140 calculating requested driving force.

Brake hold control unit 110 receives shift position SP from shift position sensor 52, an amount by which the brake pedal is operated BP from brake pedal position sensor 56, vehicular speed V from vehicular speed sensor 58, and actual value A of a degree of operation of the accelerator pedal from accelerator pedal position sensor 54 and outputs in accordance therewith a command signal to hydraulic pressure controller 68 to exert/cancel the brake hold control, and also outputs that command signal to timer 120 and unit 130 calculating a controlled value of the degree of operation of the accelerator pedal.

When timer 120 receives a command from brake hold control unit 110 to cancel the brake hold control, timer 120 starts to detect time T having elapsed since the brake hold control was cancelled, and timer 120 outputs a signal representing a detected result to unit 140 calculating requested driving force.

Unit 130 calculating a controlled value of the degree of operation of the accelerator pedal receives the command signal and actual value A of the degree of operation of the accelerator pedal from brake hold control unit 110 and accelerator pedal position sensor 54, respectively, sets controlled value AC of the degree of operation of the accelerator pedal in accordance therewith, and transmits it to unit 140 calculating requested driving force.

Unit 140 calculating requested driving force calculates requested driving force F from vehicular speed V received from vehicular speed sensor 58, actual value A of the degree of operation of the accelerator pedal received from accelerator pedal position sensor 54, time T having elapsed received from timer 120, and controlled value AC of the degree of operation of the accelerator pedal received from unit 130 calculating a controlled value of the degree of operation of an accelerator pedal, and controls inverter 34 to cause motor 30 to output a torque corresponding to requested driving force F calculated.

The control device having such a function block according to the present embodiment can also be implemented by hardware mainly of a configuration of a digital circuit, an analog circuit and the like, or software mainly of CPU 102 and ROM 104 included in ECU 100 and a program read from ROM 104 and executed by CPU 102. In general, it is said that the control device implemented by hardware is advantageous in speed of operation and that the control device implemented by software is advantageous in changing a design. Hereinafter will be described a control device implemented as software. Note that a storage medium having such a program stored therein is also a manner of the present invention.

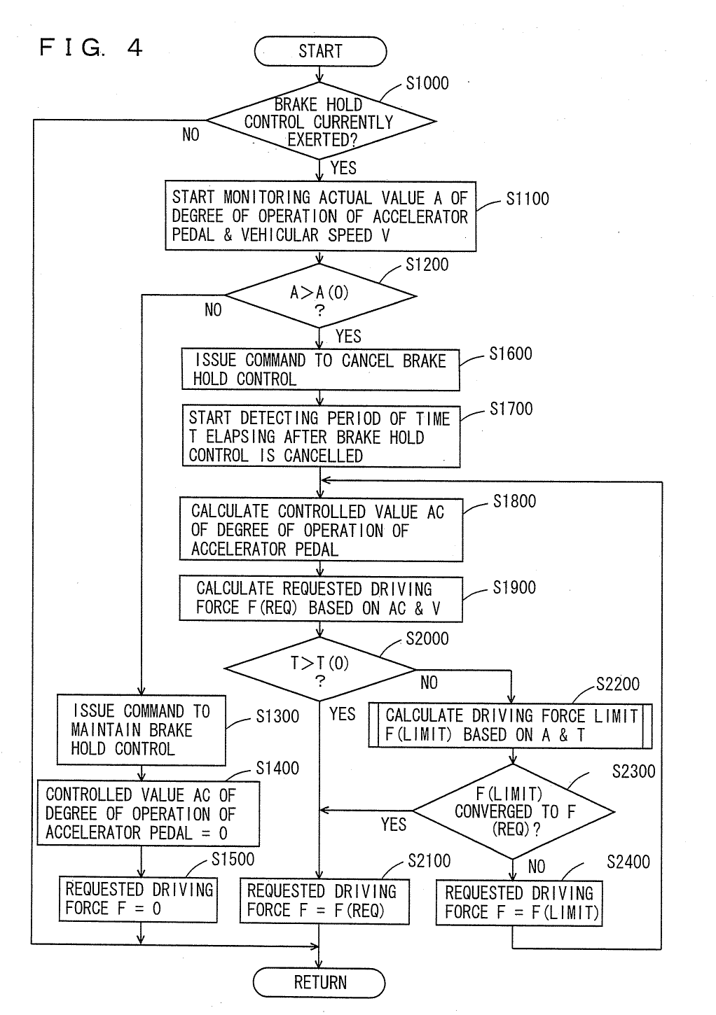

With reference to FIG. 4, the control device according to the present embodiment, or ECU 100, executes a program having a structure for control, as will be described hereinafter. Note that this program is repeatedly executed at a predetermined cycle time.

In step (S) 100, ECU 1000 determines whether the brake hold control is currently exerted. If so (YES in S1000), the control proceeds to S1100. Otherwise (NO in S1000), the process ends.

In S1100, ECU 100 starts monitoring actual value A of a degree of operation of the accelerator pedal received from accelerator pedal position sensor 54, and vehicular speed V received from vehicular speed sensor 58.

In S1200, ECU 100 determines whether actual value A of the degree of operation of the accelerator pedal is larger than predetermined degree A(0). Note that, as has been set forth above, predetermined degree A(0) is a value that allows a decision to be made that accelerator pedal position sensor 54 normally functions and ensures the driver's request for acceleration in reliability. If actual value A of the degree of operation of the accelerator pedal is larger than predetermined degree A(0) (YES in S1200), the control proceeds to S1600. Otherwise (NO in S1200), the control proceeds to S1300.

In S1300, ECU 100 outputs a command to hydraulic pressure controller 68 to maintain the brake hold control. In S1400, ECU 100 sets controlled value AC of the degree of operation of the accelerator pedal at zero. In S1500, ECU 100 sets requested driving force F at zero.

In S1600, ECU 100 outputs a command to hydraulic pressure controller 68 to cancel the brake hold control.

In S1700, ECU 100 starts to detect time T having elapsed since the brake hold control was cancelled.

In S1800, ECU 100 calculates controlled value AC of the degree of operation of the accelerator pedal. For example, ECU 100 calculates a previous controlled value AC of a degree of operation of the accelerator pedal plus a predetermined increased amount as a current controlled value AC of a degree of operation of the accelerator pedal, although how controlled value AC of the degree of operation of the accelerator pedal is calculated is not limited thereto.

In S1900, ECU 100 calculates requested driving force F (REQ) based on controlled value AC of the degree of operation of the accelerator pedal and vehicular speed V. For example, ECU 100 calculates requested driving force F (REQ) based on a map having controlled value AC of the degree of operation of the accelerator pedal and vehicular speed V as parameters.

In S2000, ECU 100 determines whether time T having elapsed since the brake hold control was cancelled exceeds a predetermined time T(0). Predetermined time T (0) is set based on a period of time that passes after reducing the brake fluid's pressure adjusted by hydraulic pressure controller 68 starts before doing so is completed (the brake fluid's pressure reduction time). If time T has exceeded predetermined time T(0) (YES in S2000), the control proceeds to S2100. Otherwise (NO in S2000), the control proceeds to S2200. In S2100, ECU 100 sets requested driving force F (REQ) as requested driving force F.

In S2200, ECU 100 calculates a driving force limit F(LIMIT) based on actual value A of the degree of operation of the accelerator pedal and time T having elapsed. ECU 100 calculates driving force limit F(LIMIT) to have a value smaller than requested driving force F (REQ). How driving force limit F(LIMIT) is calculated will be described later.

In S2300, ECU 100 determines whether driving force limit F(LIMIT) has converged to requested driving force F (REQ). If so, (YES in S2300), the control proceeds to S2100. Otherwise (NO in S2300), the control proceeds to S2400.

In S2400, ECU 100 sets driving force limit F(LIMIT) as requested driving force F.

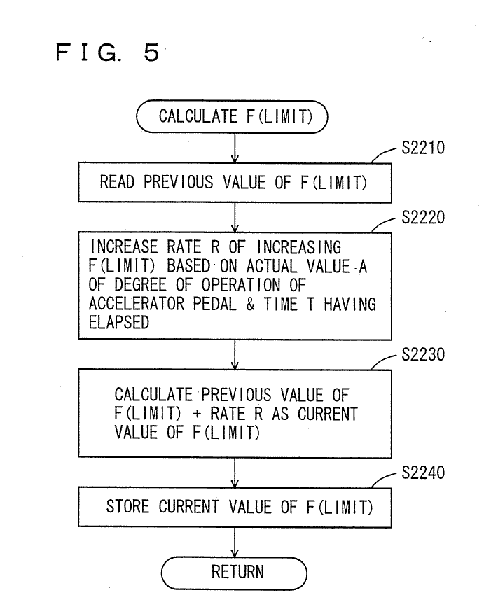

With reference to FIG. 5, when the FIG. 4 S2200 is performed, i.e., when driving force limit F(LIMIT) is calculated, ECU 100 executes a program having a structure for control, as will be described hereinafter.

In S2210, ECU 100 reads a previous value of driving force limit F(LIMIT) calculated in a previous cycle (i.e., driving force limit F(LIMIT) calculated in the previous cycle). Note that driving force limit F(LIMIT) has an initial value of zero.

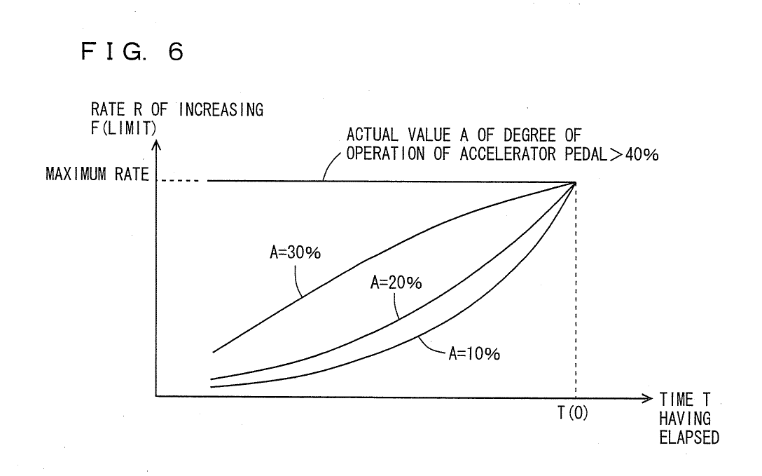

In S2220, ECU 100 calculates rate R of increasing driving force limit F(LIMIT), as based on actual value A of the degree of operation of the accelerator pedal and time T having elapsed since the brake hold control was cancelled. For example, ECU 100 calculates rate R of increasing driving force limit F(LIMIT), as based on a map having as parameters actual value A of the degree of operation of the accelerator pedal and time T having elapsed since the brake hold control was cancelled, as shown in FIG. 6. In the FIG. 6 map, rate R of increasing driving force limit F(LIMIT) for an actual value A of the degree of operation of the accelerator pedal up to 40% is calculated to be larger for longer times T having elapsed since the brake hold control was cancelled, and is also calculated to be larger for larger actual values A of the degree of operation of the accelerator pedal, and once actual value A of the degree of operation of the accelerator pedal has exceeded 40%, rate R of increasing driving force limit F(LIMIT) is calculated to be a fixed maximum rate, although how rate R of increasing driving force limit F(LIMIT) is calculated is not limited thereto.

In S2230, ECU 100 calculates the previous value of driving force limit F(LIMIT) plus rate R of increasing driving force limit F(LIMIT) as the current value of driving force limit F(LIMIT). In S2240, ECU 100 stores the current value of driving force limit F(LIMIT).

In accordance with the above structure and flowchart, the control device according to the present embodiment, or ECU 100, calculates requested driving force F, as will be described hereinafter.

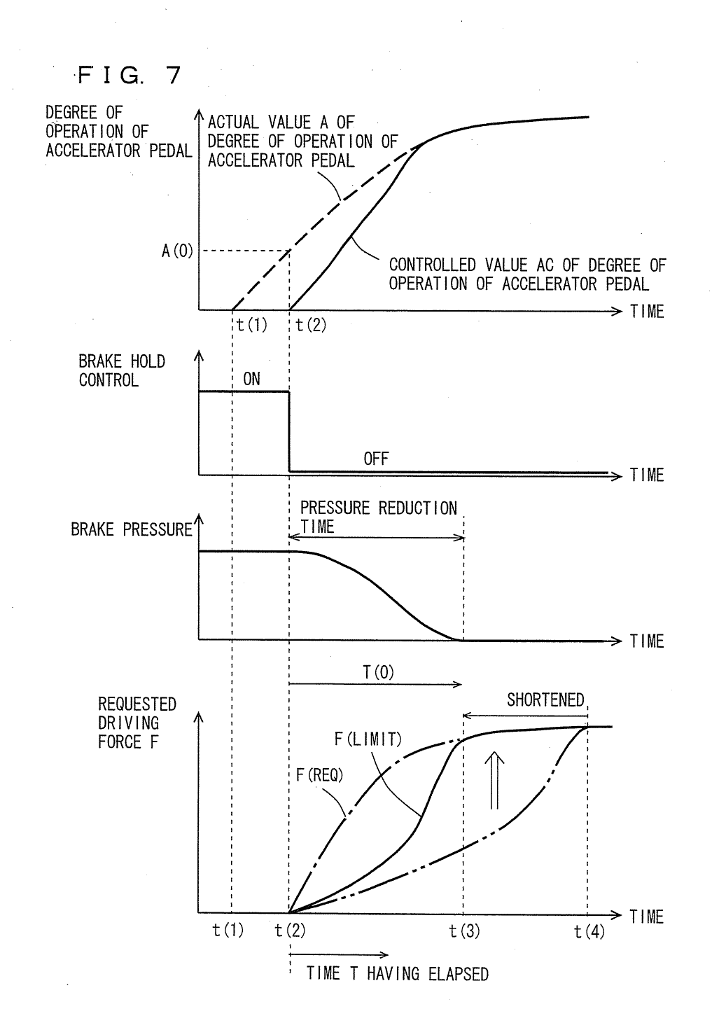

As shown in FIG. 7, while the brake hold control is exerted (YES in S1000), actual value A of a degree of operation of the accelerator pedal starts to increase at time t(1) for the sake of illustration.

While actual value A of the degree of operation of the accelerator pedal is smaller than predetermined degree A(0), or before time t(2) (NO in S1200), the brake hold control is maintained (S1300), and controlled value AC of the degree of operation of the accelerator pedal is set at zero (S1400), and requested driving force F is set at zero (S1500). The brake hold control can thus be exerted without motor 30 driven to wastefully consume electric power.

At time t(2), actual value A of the degree of operation of the accelerator pedal increases to predetermined degree A(0) (YES in S1200), and in response, as shown in FIG. 7, the brake hold control is cancelled (S1600). Subsequently, detecting time T having elapsed since the brake hold control was cancelled is started (S1700) and controlled value AC of the degree of operation of the accelerator pedal starts to increase (S1800), and requested driving force F (REQ) is calculated based on controlled value AC of the degree of operation of the accelerator pedal and vehicular speed V (S1900).

Before time T having elapsed since the brake hold control was cancelled exceeds predetermined time T(0) (NO in S2000), driving force limit F(LIMIT) smaller than requested driving force F (REQ) is calculated (S2200), and that driving force limit F(LIMIT) is set as requested driving force F (S2400). This can limit an amount by which requested driving force F is increased per unit time, and thus reduce/prevent a shock caused when the vehicle starts.

Note that predetermined time T(0) is set based on the brake fluid's pressure reduction time. As such, while reducing the brake fluid's pressure is not completed (i.e., while a braking force is exerted), rapidly increased requested driving force F can be prevented. Wasteful electric power consumption can be avoided.

Furthermore, rate R of increasing driving force limit F(LIMIT) is calculated to be larger for longer times T having elapsed since the brake hold control was cancelled, and rate R is also calculated to be larger for larger actual values A of the degree of operation of the accelerator pedal, as shown in FIG. 6 (S2220). Thus, immediately after the brake hold control is cancelled, rate R of increasing driving force limit F(LIMIT) can be set to be small to prevent a shock otherwise caused when the vehicle suddenly starts, and thereafter, depending on a period of time having elapsed since then and actual value A of the degree of operation of the accelerator pedal, rate R of increasing driving force limit F(LIMIT) can be increased. When this is compared for example with requested driving force F limited by a fixed amount increased per unit time (as indicated in FIG. 7 by a chain double-dashed line), driving force limit F(LIMIT), converged for the latter to requested driving force F (REQ) at time t(4), can be converged for the former thereto in a shorter period of time, i.e., at time t(3). A driving force as the driver requests can be output early.

The present embodiment can thus provide such a control device that after brake hold control is cancelled before a predetermined time elapses an amount by which a requested driving force is increased per unit time is calculated to be larger for longer times T having elapsed since the brake hold control was cancelled and the amount is also calculated to be larger for larger actual values of a degree of operation of an accelerator pedal. Thus, immediately after the brake hold control is cancelled, the amount by which the driving force is increased per unit time can be set to be small to prevent a shock otherwise caused when the vehicle suddenly starts, and thereafter, depending on a period of time having elapsed since then and the actual value of the degree of operation of the accelerator pedal, the amount by which the driving force is increased per unit time can be increased. This can reduce/prevent a shock otherwise caused by a vehicle suddenly starting when brake hold control is cancelled, and also output the driver's requested driving force early to achieve startability as the driver requests.

Note that in the present embodiment the FIG. 5 flowchart at S2220 and the FIG. 6 map may be modified to cause ECU 100 to calculate rate R of increasing driving force limit F(LIMIT), as based on controlled value AC of a degree of operation of the accelerator pedal and time T having elapsed since the brake hold control was cancelled. Actual value A of the degree of operation of the accelerator pedal may thus be replaced with controlled value AC of the degree of operation of the accelerator pedal to calculate rate R of increasing driving force limit F(LIMIT), since it can be said that controlled value AC of the degree of operation of the accelerator pedal has a positive correlation with actual value A of the degree of operation of the accelerator pedal and is a value corresponding to the driver's request for acceleration. A driving force can thus be increased early in response to the driver's request.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

1. A vehicular control device for a vehicle having a brake hold control function causing a braking device to operate to hold a braking force while a driver of said vehicle does not press a brake pedal, and stopping said braking device from operating when a degree of acceleration requested by the driver is larger than a predetermined degree, the vehicular control device comprising:
a detection unit that detects said degree requested; and
a control unit connected to said detection unit, wherein while said brake hold control is exerted, said control unit determines whether said degree requested, as detected by said detection unit, exceeds said predetermined degree, and said control unit detects a period of time having elapsed since said degree requested exceeded said predetermined degree, and for said degree requested having exceeded said predetermined degree, before said period of time having elapsed exceeds a predetermined time, said control unit sets a degree of increasing requested driving force, as based on said period of time having elapsed and said degree requested, calculates said requested driving force, as based on said degree as set of increasing said requested driving force, and controls force driving said vehicle, as based on said requested driving force as calculated.

2. The vehicular control device according to claim 1, wherein said control unit sets an amount by which said requested driving force is increased per unit time to be larger amounts for larger values of said degree requested.

3. The vehicular control device according to claim 1, wherein said control unit sets an amount by which said requested driving force is increased per unit time to be larger amounts for larger values of said period of time having elapsed.

4. The vehicular control device according to claim 1, wherein:
said braking device is a hydraulic braking device; and
said predetermined time is set as based on a period of time elapsing after said braking device starts to reduce a pressure of a brake fluid before said braking device completes reducing said pressure of said brake fluid.

5. A vehicular control device for a vehicle having a brake hold control function causing a braking device to operate to hold a braking force while a driver of said vehicle does not press a brake pedal, and stopping said braking device from operating when a degree of acceleration requested by the driver is larger than a predetermined degree, the vehicular control device comprising:
a device that calculates requested driving force based on a state of said vehicle; and
a device that controls force driving said vehicle, as based on said requested driving force, said device that calculates requested driving force including:
a device that detects said degree requested;
a device that determines whether said degree requested exceeds said predetermined degree while said brake hold control is exerted;
a device that detects a period of time having elapsed since said degree requested exceeded said predetermined degree;
a setting device that sets a degree of increasing said requested driving force, as based on said period of time having elapsed and said degree requested, for said degree requested having exceeded said predetermined degree, before said period of time having elapsed exceeds a predetermined time; and
a device that calculates said requested driving force based on said degree of increasing said requested driving force.

6. The vehicular control device according to claim 5, wherein said setting device includes a device that sets an amount by which said requested driving force is increased per unit time to be larger amounts for larger values of said degree requested.

7. The vehicular control device according to claim 5, wherein said setting device includes a device that sets an amount by which said requested driving force is increased per unit time to be larger amounts for larger values of said period of time having elapsed.

8. The vehicular control device according to claim 5, wherein:
said braking device is a hydraulic braking device; and
said predetermined time is set as based on a period of time elapsing after said braking device starts to reduce a pressure of a brake fluid before said braking device completes reducing said pressure of said brake fluid.

9. A method for controlling a vehicle having a brake hold control function causing a braking device to operate to hold a braking force while a driver of said vehicle does not press a brake pedal, and stopping said braking device from operating when a degree of acceleration requested by the driver is larger than a predetermined degree, the method comprising—the steps of:
calculating requested driving force based on a state of said vehicle; and
controlling force driving said vehicle, as based on said requested driving force, the step of calculating including the steps of:
detecting said degree requested;
determining whether said degree requested exceeds said predetermined degree while said brake hold control is exerted;
detecting a period of time having elapsed since said degree requested exceeded said predetermined degree;
setting a degree of increasing said requested driving force, as based on said period of time having elapsed and said degree requested, for said degree requested having exceeded said predetermined degree, before said period of time having elapsed exceeds a predetermined time; and
calculating said requested driving force based on said degree of increasing said requested driving force.

10. The method for controlling a vehicle according to claim 9, wherein the step of setting includes the step of setting an amount by which said requested driving force is increased per unit time to be larger amounts for larger values of said degree requested.

11. The method for controlling a vehicle according to claim 9, wherein the step of setting includes the step of setting an amount by which said requested driving force is increased per unit time to be larger amounts for larger values of said period of time having elapsed.

12. The method for controlling a vehicle according to claim 9, wherein:
said braking device is a hydraulic braking device; and
said predetermined time is set as based on a period of time elapsing after said braking device starts to reduce a pressure of a brake fluid before said braking device completes reducing said pressure of said brake fluid.
